(19) United States
(12) Patent Application Publication
(10) Pub. No.: US 2026/0166835 A1
(43) Pub. Date: Jun. 18, 2026

(54) TABLET PRESS COMPRISING A DISCHARGE CHUTE, A DISCHARGE SYSTEM FOR A TABLET PRESS AND A TABLET PRESS COMPRISING A CORRESPONDING DISCHARGE SYSTEM

(71) Applicant: Syntegon Technology GmbH, Waiblingen (DE)

(72) Inventors: Fabian Werner, Waiblingen (DE); Till Bastian Wetterauer, Waiblingen (DE); Torsten Grass, Urbach (DE)

(21) Appl. No.: 19/123,573

(22) PCT Filed: Aug. 29, 2023
(86) PCT No.: PCT/EP2023/073616

§ 371 Date: Apr. 23, 2025

(30) Foreign Application Priority Data
Nov. 4, 2022 (DE) 10 2022 129 223.1

(51) Int. Cl. B30B 15/32; B30B 11/02; B65G 11/20

(52) U.S. Cl. CPC B30B 15/32; B65G 11/203; B30B 11/02; B65G 2201/027

(57) ABSTRACT

The invention relates to a discharge chute (2) for a tablet press (1), to a discharge system (27) for a tablet press (1), and to a tablet press (1) having a corresponding discharge chute (2) or a corresponding discharge system (27).

### BACKGROUND

The present invention relates to a tablet press comprising a discharge chute. Furthermore, the present invention relates to a discharge system for a tablet press. Furthermore, the present invention relates to a tablet press comprising a corresponding discharge system.

Tablet presses are used, for example, in the pharmaceutical industry, the technical industry, the chemical industry or the food industry to produce tablets or pellets in large quantities. Typically, tablet presses are divided into rotary presses and eccentric presses, with rotary presses generally having a larger production capacity compared to eccentric presses. A rotary press comprises a rotatably mounted die plate with die openings formed therein. Each of the die openings is assigned an upper punch and a lower punch. The upper and lower punches can rotate with the die plate. As the die plate rotates, the die openings are filled with powdered materials. In at least one pressing device, the upper and lower punches are pressed against one another in the die openings to compress the materials into tablets. After compression, the tablets are usually ejected from the die openings by the lower punches and fed to a discharge chute of the tablet press, for example by a scraper.

In its simplest form, the discharge chute consists of a chute channel with only one tablet outlet. The discharge chute protrudes diagonally downwards from the top of the die plate out of the tablet press.

However, such discharge chutes are also known whose chute channel comprises at least a first tablet outlet and a second tablet outlet. Tablets fed into the tablet inlet of the chute channel are routed to the different tablet outlets, for example depending on measured values from a sensor system of the tablet press. For example, good tablets are fed to one of the tablet outlets and bad tablets are fed to the other of the tablet outlets. In order to guide the tablets to the desired tablet outlet, such discharge chutes typically have an actuating element that can be pivoted between a first end position and a second end position. In the first end position of the actuating element, tablets fed to the tablet inlet of the chute channel are fed to at least the first tablet outlet. In the second end position of the actuating element, tablets fed to the tablet inlet are fed to at least the second tablet outlet. When the actuating element is pivoted into the first end position, the actuating element is pivoted in the direction of a wall delimiting the chute channel, which is referred to below as the first wall. Known discharge chutes have the problem that tablets can become trapped between the actuating element and the first wall when the actuating element is pivoted into the first end position. Such a “tablet jam” results in a gap remaining between the first wall and the actuating element through which tablets can slip. Such tablets are then not directed to the first tablet outlet as desired, but to the second tablet outlet. If the second tablet outlet is the tablet outlet for good tablets, this can, for example, lead to bad tablets incorrectly exiting the tablet outlet for good tablets. In some cases, all tablets collected in a collection container downstream of the second tablet outlet must then be discarded.

A discharge chute of the generic type is known from the laid open application DE 10 2018 116 143 A1, for example. In this discharge chute, the actuating element rests in the first end position against the first wall. The previously mentioned tablet jams are avoided by reducing the speed of movement with which the actuating element is moved towards the first end position before the first end position is reached. Such a design of the discharge chute is complex to implement. For example, there must be a sensor system that detects the current position of the actuating element. In addition, there must also be a drive device that can implement a desired reduction in the movement speed of the actuating element with sufficient precision.

From KR 101 614 462 B1, a discharge chute is known which comprises a rotatable adjusting roller as an actuating element. The adjusting roller is integrated into a bottom of the discharge chute and can rotate about an axis of rotation aligned perpendicular to the sliding direction of the discharge chute. The adjusting roller comprises two adjusting projections that protrude into the chute channel of the discharge chute to guide the tablets.

The invention is based on the object of providing a possibility for preventing the aforementioned tablet jamming with simple constructive means and to safely guide the supplied tablets to the desired tablet outlet.

### SUMMARY

This object is achieved according to the invention by a tablet press, by a discharge system, and by a tablet press.

The description indicates advantageous variants and embodiments.

According to the invention, a tablet press is therefore provided which is designed to produce tablets having a predetermined size. The size of the tablets is determined, for example, by the shape of the die openings in the die plate. The tablet press comprises a discharge chute. The discharge chute comprises a chute channel with at least one tablet inlet. In addition, the discharge chute comprises an actuating element, in particular a switch vane, which can be pivoted between a first end position and a second end position. The first end position and the second end position together limit the pivot path of the actuating element. Tablets fed to the tablet inlet of the chute channel are fed in the first end position of the actuating element to at least a first tablet outlet of the chute channel. The sliding path to the second tablet outlet is preferably blocked in the first end position by the actuating element. In the second end position of the actuating element, however, the tablets fed to the tablet inlet are fed to at least a second tablet outlet of the chute channel. The sliding path to the first tablet outlet is preferably blocked in the second end position by the actuating element. In the first end position, the actuating element points in the direction of a first wall that limits the chute channel. In particular, the first wall is a first side wall.

It is now provided that, in each position of the actuating element, a passage is formed between the actuating element and the first wall which is larger than the maximum extension of the tablets produced by the tablet press. The term “each position” includes the first end position, the second end position, and all intermediate positions of the actuating element. Because the passage is always larger than the maximum extension of the tablets produced, tablet jams are reliably avoided. If the actuating element strikes a tablet when pivoting into the first end position, the tablet will at most be pushed by the actuating element in the direction of the first wall. However, it is not possible for the tablet to become jammed between the actuating element and the first wall, because the passage is always larger than the maximum extension of the tablet. Preferably, in addition to the first wall, the discharge chute comprises a second wall, or second side wall, opposite the first wall. If the actuating element is pivoted from the second end position to the first end position, the actuating element is pivoted in the direction of the first wall. If the actuating element is pivoted from the first end position to the second end position, the actuating element is pivoted in the direction of the second wall.

According to a preferred embodiment, it is provided that the actuating element in the first end position points in the direction of an in particular lateral recess of the first wall. The recess makes it easy to create a passage having a desired size. Preferably, in the first end position the actuating element protrudes into the recess of the first wall. This reliably prevents tablets from striking a free first end of the actuating element. This could otherwise result in the tablets, after hitting the free end, moving through the passage between the actuating element and the first wall to the second tablet outlet, which is undesirable. In addition, striking the free end could damage the tablet in question. This is certainly undesirable in the case of good tablets. Both good and bad tablets could also chip, which could contaminate the chute channel. Alternatively, the actuating element extends in the first end position up to the recess. This is the case for example if the free end of the actuating element in the first end position is arranged on an imaginary extension of a wall portion which is arranged in front of the recess. Preferably, the first wall is a first side wall of the discharge chute. The recess is then a lateral recess. A recess in a wall designates a wall setback. Viewed from the chute channel, the recess can be seen as an indentation. The wall portion of the first wall forming the recess is also referred to below as the first wall portion.

According to a preferred embodiment, it is provided that a pivoting of the actuating element beyond the first end position is blocked by a first stop element, and/or that a pivoting of the actuating element beyond the second end position is blocked by a second stop element. This ensures that the first end position or the second end position is securely defined. In particular, the first stop element or the second stop element interacts in the first end position or the second end position directly with the actuating element. Alternatively, the first stop element or the second stop element in the first end position or the second end position cooperate with an element that is mechanically coupled to the actuating element.

According to a preferred embodiment, it is provided that the passage between the actuating element and the first wall in the first end position is at most 30 mm. With a passage having this dimension, jamming of commercially available tablets can be safely avoided.

Preferably, the passage in the first end position is between 20 mm and 30 mm, preferably between 15 mm and 20 mm, preferably between 10 mm and 15 mm, preferably between 5 mm and 10 mm.

According to a preferred embodiment, it is provided that the first wall portion is formed at least in regions by an insert part which is inserted into a cavity in the first wall and is detachably connected to the discharge chute. If the insert part is inserted into the cavity, the insert part or its outer contour also forms the first wall. Preferably, only some regions of the first wall portion are formed by the inserted insert part. However, the entire first wall portion can also be formed by the inserted insert part. The insert part offers the advantage that the passage between the actuating element and the first wall can be modified, for example by removing the insert part and inserting another insert part with a different outer contour. A change of the first end position is not necessary for this. For example, for tablets of a given first size, a different insert part is inserted into the cavity than for tablets of a given second size. Preferably, the insert part is connected to the discharge chute by a detachable positive-fit connection and/or by at least one detachable fastening element. It is preferred for the insert part to be present. The advantageous prevention of tablet jamming can also be achieved by a one-piece first wall with a corresponding contour.

According to a preferred embodiment, it is provided that the first wall, in particular the inserted insert part, in the first end position of the actuating element extends in an arc-shaped manner along the free first end of the actuating element. The arced shape allows for advantageous tablet guidance. Preferably, the portion of the first wall extending in an arc-shaped manner along the free end is formed by the insert part. The arc-shaped portion is particularly relevant for the definition of the passage, so that the formation of the arc-shaped portion by the insert part offers a particularly wide range of possibilities with regard to a desired adaptation of the passage to different tablet sizes.

According to a preferred embodiment, it is provided that a second wall portion of the first wall arranged upstream of the first wall portion extends in the sliding direction of the discharge chute, and/or that a third wall portion of the first wall arranged downstream of the first wall portion extends in the sliding direction of the discharge chute. If an element is arranged upstream of another element, the element is arranged between the tablet inlet and the other element. If an element is arranged downstream of another element, the other element is arranged between the tablet inlet and the element. By means of a second wall portion or third wall portion extending in the sliding direction, an advantageous guiding of the tablets in the region of the second wall portion or third wall portion is achieved. Preferably, the second wall portion and the third wall portion lie in a common imaginary plane. However, the second wall portion and the third wall portion can also both extend in the sliding direction and be axially offset from one another with respect to an axis oriented perpendicular to the second and third wall portions.

According to a preferred embodiment, it is provided that the second wall portion is formed at least in regions by the insert part. This allows the passage between the actuating element and the first wall portion to be adjusted particularly precisely. Specifically, by lengthening or shortening the region of the second wall portion formed by the insert part, the passage between the actuating element and the transition of the second wall portion into the first wall portion can be reduced or increased.

Preferably, the chute channel is divided by a partition wall arranged downstream of the actuating element into a first chute channel part assigned to the first tablet outlet and a second chute channel part assigned to the second tablet outlet. This prevents the tablets from mixing in a region of the chute channel downstream of the actuating element. Preferably, a passage between the actuating element and the partition wall is smaller in each position of the actuating element than the minimum size of the tablets produced by the tablet press. This is a particularly effective way to prevent the tablets from mixing. Preferably, the partition wall in the second end position of the actuating element is aligned with the actuating element.

Preferably, the discharge chute comprises a bottom extending perpendicular to the first wall. If the bottom extends perpendicular to the first wall, a suitable actuating element can be easily implemented. For example, a rectangular actuating element is used. Preferably, the chute channel has a rectangular cross section.

According to a preferred embodiment, it is provided that the discharge chute comprises a pneumatic drive device for pivoting the actuating element. Such a drive device is associated with low manufacturing costs for the discharge chute. Sometimes intermediate positions of the actuating element between the two end positions cannot be precisely set using a pneumatic drive device. In view of the functioning of the discharge chute according to the invention, however, this is not necessary. The two end positions of the actuating element can be set reliably and quickly using the pneumatic drive device. Preferably, the pneumatic drive device comprises a rotary cylinder with an output shaft, wherein the actuating element is arranged on the output shaft in a rotationally fixed manner. As previously mentioned, the stop elements can cooperate with an element to which the actuating element is mechanically coupled. In particular, the stop elements limit the rotation of a pivoting blade in the rotary cylinder.

According to a preferred embodiment, it is provided that the chute channel comprises a third tablet outlet, wherein tablets fed to the tablet inlet are selectively fed in the first end position to the first tablet outlet or the third tablet outlet, and/or wherein tablets fed to the tablet inlet are selectively fed in the second end position to the second tablet outlet or the third tablet outlet. The third tablet outlet can further increase the functionality of the discharge chute. Specifically, the third tablet outlet can be used, for example, for taking a sample, i.e., a random sample examination of tablets. Preferably, the discharge chute comprises a further actuating element arranged downstream of the actuating element, in particular a further switch vane, which, depending on its position, selectively guides the tablets to the first tablet outlet or the third tablet outlet, or the second tablet outlet or the third tablet outlet. Particularly preferably, the discharge chute is designed such that tablets fed to the tablet inlet are selectively fed in the first end position of the actuating element to the first tablet outlet or the third tablet outlet.

The object to be achieved is also achieved by a discharge system for a tablet press, in particular a rotary press.

A discharge system according to the invention comprises a chute channel with at least one tablet inlet and an actuating element, in particular a switch vane, which can be pivoted between a first end position and a second end position. Tablets fed to the tablet inlet are fed in the first end position of the actuating element to at least a first tablet outlet of the chute channel. In the second end position of the actuating element, tablets fed to the tablet inlet are fed to at least a second tablet outlet of the chute channel. The chute channel is delimited in some regions by a first wall of the discharge chute, wherein the first wall includes a cavity. Preferably, the first wall is a first side wall.

The discharge system also comprises at least one insert part that can be inserted into the cavity. If the insert part is inserted into the cavity, the insert part or its outer contour also forms the first wall.

Furthermore, it is provided that the actuating element in the first end position points in the direction of the inserted insert part, and that when the insert part is inserted a passage is formed between the actuating element and the first wall in each position of the actuating element. Because the passage between the first wall and the actuating element is present in every position of the actuating element, tablet jams can be effectively avoided, as already mentioned above. The insert part also makes it possible to vary the passage between the actuating element and the first wall, for example by replacing the insert part with another insert part with a different outer contour. Preferably, the insert part forms part of the first wall in such a way that the first wall comprises a recess in the region of the insert part. The actuating element in the first end position then points in the direction of the recess. Preferably, the actuating element protrudes into the recess or up to the recess. This can prevent tablets from striking a free first end of the actuating element. The wall portion of the first wall forming the recess is also referred to below as the first wall portion. Preferably, only some regions of the first wall portion are formed by the inserted insert part. However, the first wall portion can also be formed entirely by the inserted insert part. Preferably, when the insert part is inserted in the first end position of the actuating element, the passage is at most 30 mm, preferably between 20 mm and 30 mm, preferably between 15 mm and 20 mm, preferably between 10 mm and 15 mm, preferably between 5 mm and 10 mm.

Advantages and possible developments of the discharge chute are to be understood as also being described in relation to the discharge system and, conversely, advantages and possible developments of the discharge system are to be understood as also being described in relation to the discharge chute.

According to a preferred embodiment, it is provided that the discharge system comprises at least one further insert part, wherein either the insert part or the further insert part can be inserted into the cavity, and wherein the passage between the actuating element and the first wall is different when the insert part is inserted than when the further insert part is inserted. This allows an advantageous adaptation of the discharge chute to the size of the tablets produced. Preferably, the discharge system comprises a plurality of additional insert parts, each differing from one another in its outer contour.

Preferably, the discharge system comprises a further insert part which is designed such that when the further insert part is inserted, the actuating element in the first end position rests against the inserted further insert part. In conventional discharge chutes, the actuating element in the first end position is usually positioned against a wall of the discharge chute.

Tablet jams cannot be reliably avoided with such a discharge chute. However, an additional corresponding insert part offers the advantage that a discharge chute with the conventional functionality can still be retained if desired. By adding such a further insert part, the field of application of the discharge system is expanded.

The object to be achieved is also achieved by a tablet press, in particular a rotary press, which is designed to produce tablets of a predetermined size. The tablet press comprises a discharge system having the features described above.

With regard to the advantages that can be achieved by means of the tablet press, reference is made to the statements in this regard relating to the discharge chute or the discharge system. The features described in connection with the discharge chute or the discharge system can serve for further developing the tablet press.

### BRIEF DESCRIPTION OF THE DRAWINGS

The invention is described in more detail below with reference to the figures, the same or functionally equivalent elements possibly being provided with reference signs only once. The description serves as an example and is not to be understood as limiting. In the figures:

FIG. 1 shows a tablet press;

FIG. 2 shows a discharge chute with an insert part;

FIG. 3 is another view of the discharge chute shown in FIG. 2;

FIG. 4 shows different insert parts for the discharge chute;

FIG. 5 shows the discharge chute with another insert part;

FIG. 6 shows the discharge chute with another insert part; and

FIG. 7 shows the discharge chute with another insert part.

### DETAILED DESCRIPTION

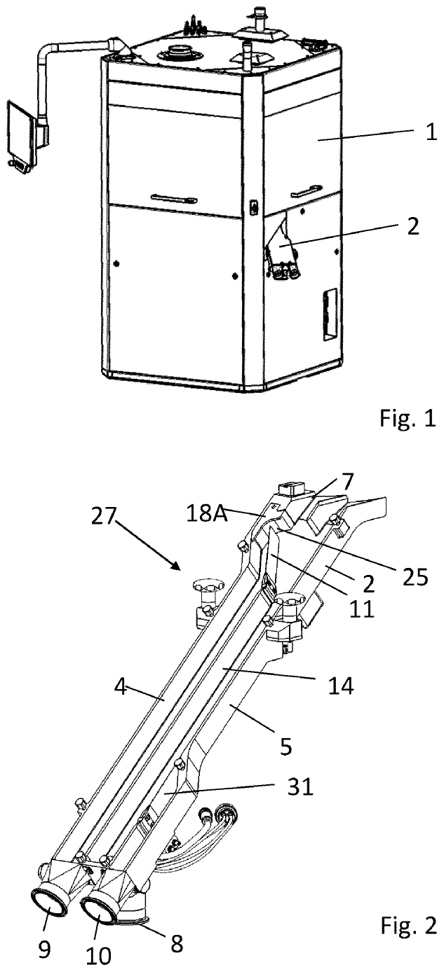

FIG. 1 shows a perspective view of a tablet press 1. In the present case, the tablet press 1 is designed as a rotary press 1. The tablet press 1 comprises a discharge chute 2 for tablets produced by the tablet press 1.

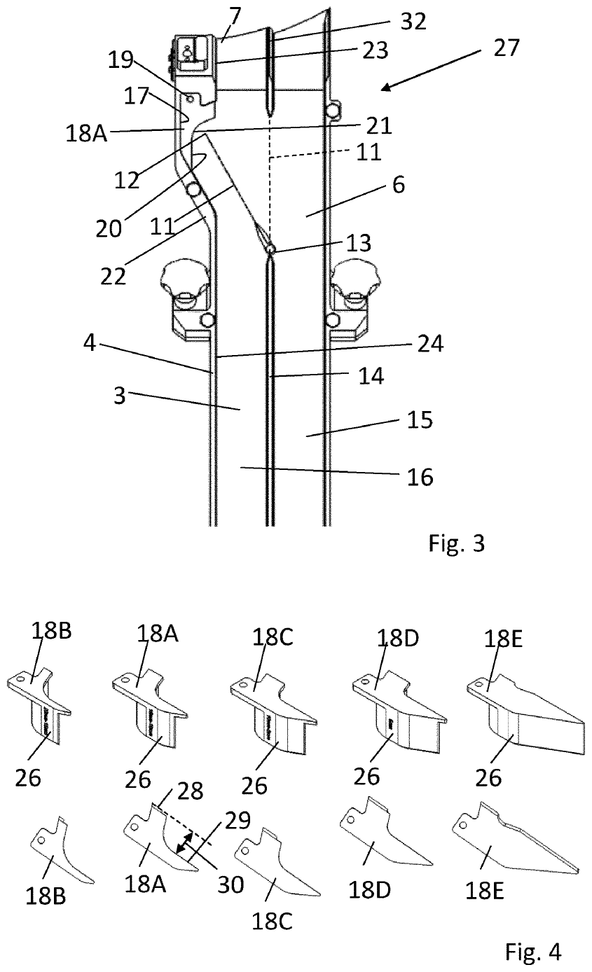

In the following, the realization of the discharge chute 2 is explained in more detail with reference to FIGS. 2 and 3. For this purpose, FIG. 2 shows a perspective view of the discharge chute 2. FIG. 3 shows a top view of the discharge chute 2.

The discharge chute 2 comprises a chute channel 3. The chute channel 3 is delimited by a first side wall 4, a second side wall 5 opposite the first side wall 4, and a bottom 6. In addition, the chute channel 3 is limited by a cover not shown in FIGS. 2 and 3. The bottom 6 extends perpendicular to the two side walls 4 and 5. In the present case, the chute channel 3 has a rectangular cross section.

The chute channel 3 comprises a tablet inlet 7. If the chute channel 3 is installed in the tablet press 1 as intended, tablets produced by the tablet press 1 are fed to the chute channel 3 through the tablet inlet 7.

The chute channel 3 also comprises at least a first tablet outlet 8 and a second tablet outlet 9. In the exemplary embodiment shown in the figures, the first tablet outlet 8 is a tablet outlet for bad tablets. The second tablet outlet 9 is a tablet outlet for good tablets. In the present case, a third tablet outlet 10 is also present. The third tablet outlet 10 is provided for sampling, i.e., a random sample examination of produced tablets.

The discharge chute 2 comprises an actuating element 11. The actuating element 11 can be pivoted between a first end position and a second end position. In the present case, the pivot axis of the actuating element 11 extends perpendicular to the bottom 6. The first end position and the second end position limit the pivot path of the actuating element 11, so that pivoting of the actuating element 11 beyond the end positions is blocked.

Preferably, a first stop element (not shown in the figures) is present which blocks a pivoting of the actuating element 11 beyond the first end position. Preferably, a second stop element (not shown in the figures) is present which blocks a pivoting of the actuating element 11 beyond the second end position. Preferably, the actuating element 11 is mechanically coupled to an output shaft of a rotary cylinder of a pneumatic drive device, wherein the stop elements limit the rotation of a pivoting blade in the rotary cylinder.

In FIGS. 2 and 3, the actuating element 11 assumes the first end position. In the first end position, the actuating element 11 extends obliquely to the sliding direction of the chute channel 3. The sliding direction of the chute channel 3 is the direction of inclination of the bottom 6. The second end position is indicated by a dashed line in FIG. 3. In the second end position, the actuating element 11 extends in the sliding direction. If the actuating element 11 is pivoted from the first end position into the second end position, the actuating element 11 is pivoted in the direction of the second side wall 5. If the actuating element 11 is pivoted from the second end position into the first end position, the actuating element 11 is pivoted in the direction of the first side wall 4.

In the first end position of the actuating element 11, tablets fed to the tablet inlet 7 are fed to the first tablet outlet 8 or the third tablet outlet 10. In the second end position of the actuating element 11, tablets fed to the tablet inlet 7 are fed to the second tablet outlet 9.

In the present case, the actuating element 11 is designed as a switch vane 11, i.e., as a flap-shaped actuating element 11. The actuating element 11 comprises a free first end 12. In addition, the actuating element 11 comprises a second end 13 facing away from the first end 12. The pivot axis of the actuating element 11 runs through the actuating element 11 in the region of the second end 13.

A partition wall 14 is arranged in the chute channel 3. The partition wall 14 is arranged downstream of the actuating element 11 and extends in the sliding direction of the chute channel 3. In the second end position of the actuating element 11, the partition wall 14 is aligned with the actuating element 11. The chute channel 3 is divided by the partition wall 14 into a first chute channel part 15 assigned to the first tablet outlet 8 and a second chute channel part 16 assigned to the second tablet outlet 9.

In the present case, a further partition wall 32 is also arranged in front of the actuating element 11. The further partition wall 32 extends in the sliding direction of the sliding channel 3. In the second end position, the actuating element 11 is aligned with the further partition wall 32.

As previously mentioned, in the first end position of the actuating element 11 the tablets fed to the tablet inlet 7 are selectively fed to the first tablet outlet 8 or the third tablet outlet 10. In order to specifically feed the tablets to the first tablet outlet 8 or the third tablet outlet 10, a further actuating element 31 is provided. The further actuating element 31 can also be pivoted between a first end position and a second end position. In the first end position shown in FIG. 2, the further actuating element 31 extends in the sliding direction of the sliding channel 3. The tablets are fed to the first tablet outlet 8. In the second end position, the further actuating element 31 extends obliquely to the sliding direction of the sliding channel 3. A free first end of the further actuating element 31 rests against the partition wall 14. The tablets are then fed to the third tablet outlet 10.

If the first side wall 4 were to extend continuously in the sliding direction of the sliding channel 3, a tablet could become trapped between the actuating element 11 and the first side wall 4 when the actuating element 11 is pivoted into the first end position. There would then be a gap between the first side wall 4 and the actuating element 11, through which tablets could mistakenly reach the second tablet outlet 9. Such “tablet jams” are effectively avoided by the design of the first side wall 4 described below.

The first side wall 4, or a base body 22 of the first side wall 4, comprises a cavity 17 at the level of the actuating element 11. An insert part 18A is inserted into the cavity 17. The insert part 18A is detachably connected to the discharge chute 2. In the present case, the detachable connection is effected by a fastening pin 19 which is inserted into a through-opening of the insert part 18A.

If the insert part 18A is inserted into the cavity 17, the chute channel 3 is limited in the region of the insert part 18A by a first outer contour 25 of the insert part 18A. In this respect, the first side wall 4 is formed jointly by the base body 22 of the first side wall 4 and the inserted insert part 18A. When the insert part 18A is inserted, the first side wall 4 comprises a lateral recess 20. A second outer contour 26 of the insert part 18A is shaped complementarily to the base body 22 and fits snugly against the base body 22.

The wall portion 21 of the first side wall 4 forming the recess 20 is referred to below as the first wall portion 21. In the present case, the first wall portion 21 is formed partly by the insert part 18A and partly by the base body 22 of the side wall 4.

A second wall portion 23 is arranged upstream of the first wall portion 21. The second wall portion 23 extends in the sliding direction of the chute channel 3. In the present case, the second wall portion 23 is formed partly by the insert part 18A and partly by the base body 22 of the side wall 4.

In addition, a third wall portion 24 is arranged downstream of the first wall portion 21. The third wall portion 24 extends in the sliding direction of the sliding channel 3. In the present case, the second wall portion 23 and the third wall portion 24 lie in a common imaginary plane.

As can be seen from FIGS. 2 and 3, the actuating element 11 in the first end position points in the direction of the recess 20. In the present case, the actuating element 11 in the first end position protrudes into the recess 20. The free first end 12 of the actuating element 11 faces the part of the first wall portion 21 formed by the insert part 18A. In the present case, the insert part 18A extends in an arc-shaped manner along the free end 12. As can be seen from FIGS. 2 and 3, in the first end position of the actuating element 11 a passage is formed between the first side wall 4 and the actuating element 11. This passage is present in every end position of the actuating element 11, and is larger in every end position of the actuating element 11 than the maximum extension of the tablets produced by the tablet press 1.

Because the passage in each position of the actuating element 11 is larger than the maximum extension of the tablets produced, a single tablet cannot become trapped between the actuating element 11 and the first side wall 4. Because the free end 12 in the first end position protrudes into the recess 20, the tablets fed to the tablet inlet 7 in the first end position of the actuating element 11 do not strike the free end 12, but at most strike a portion of the actuating element 11 arranged between the free end 12 and the second end 13.

In the embodiment shown in FIGS. 2 and 3, the discharge chute 2 and the insert part 18A together form a discharge system 27. The insertable insert part 18A has the advantage that the course of the first side wall 4 can be adapted to the size of the tablets produced. However, the above-described prevention of tablet jamming can also be realized by a one-piece first side wall 4.

According to a further embodiment of the discharge chute 2 (not shown), the first side wall 4 is formed in one piece. The course of the first side wall 4 corresponds to the course of the first side wall 4 composed of the base body 22 and the insert part 18A, as previously explained with reference to FIGS. 2 and 3.

As previously mentioned, the discharge system 27 with the insertable insert part 18A has the advantage that the course of the first side wall 4 can be adapted to the size of the tablets produced. This is explained in more detail below with reference to FIGS. 4, 5, 6, and 7.

FIG. 4 shows the insert part 18A and four further insert parts 18B, 18C, 18D, and 18E. A perspective view and a plan view of each of the insert parts 18 are shown. Either the insert part 18A or one of the other insert parts 18B, 18C, 18D, and 18E can selectively be inserted into the cavity 17.

As can be seen from FIG. 4, the insert parts 18 differ in particular with regard to their first outer contour 25. Depending on which of the insert parts 18 is inserted into the cavity 17, a first side wall 4 with a different course is thus obtained in each case.

If one of the insert parts 18A, 18B, 18C, and 18D is inserted into the cavity 17, this achieves the effect that in each position of the actuating element 11 the passage is formed between the actuating element 11 and the first side wall 4, and that the actuating element 11 in the first end position protrudes into the recess 20. The size of the passage is defined by the first outer contour 25 of the insert parts 18.

For example, the insert parts 18A, 18B, 18C, and 18D differ in the length of a first portion 28 of the first outer contour 25, which helps form the second wall portion 23 of the first side wall 4 when the insert part 18 is inserted. The first outer contour 25 also comprises a second portion 29 which extends parallel to the first portion 28. When the insert part 18 is inserted, the second portion 29 forms a bottom of the recess 20.

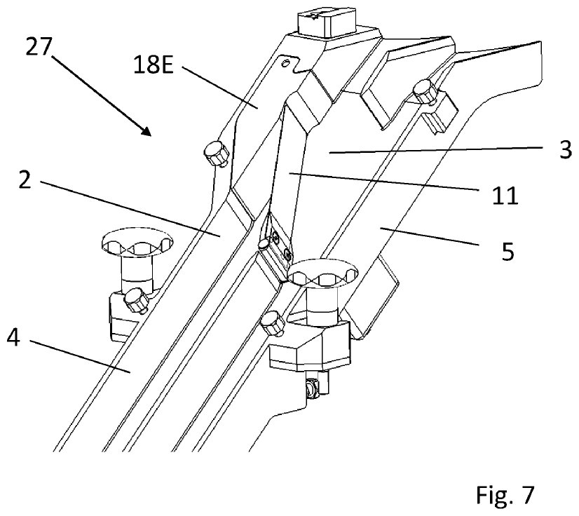

As can be seen from FIG. 7, the insert parts 18A, 18B, 18C, and 18D differ with regard to the offset 30 between the first portion 28 and the second portion 29. The offset 30 between the first portion 28 and the second portion 29 defines the depth of the recess 20 of the first side wall 4. By shortening the first portion 28 and increasing the offset 30, the size of the passage between the actuating element 11 and the first side wall 4 can be increased.

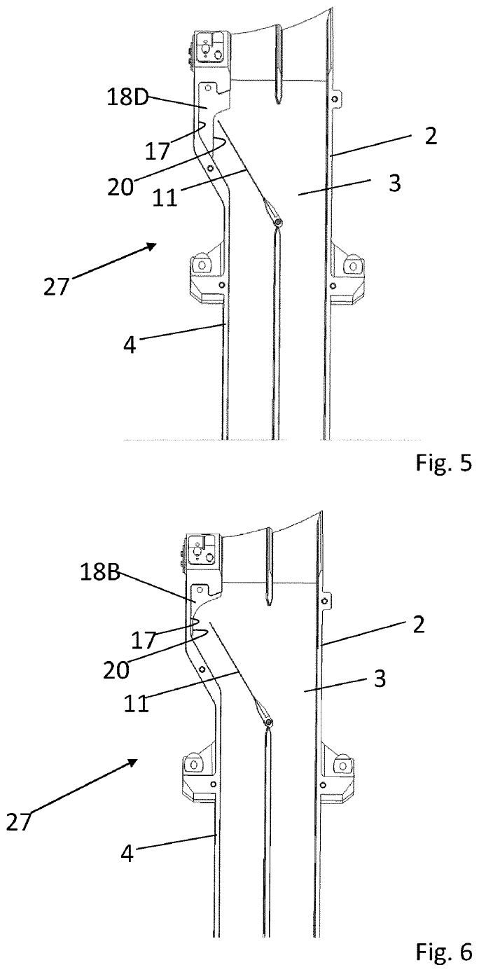

As can be seen from FIG. 5, for example, the use of the further insert part 18D results in a smaller passage than the use of the insert part 18A. As can be seen from FIG. 6, for example, the use of the further insert part 18B results in a larger passage than the use of the insert part 18A.

If the further insert part 18E is inserted into the cavity 17, the free end 12 of the actuating element 11 in the first end position rests against the further insert part 18E, as can be seen in FIG. 7. When using the additional insert part 18E, tablet jams cannot be ruled out. However, the additional insert part 18E makes it possible to realize the functionality of a conventional discharge chute by means of the discharge system 27.

1. A tablet press, which is configured to produce tablets having a predetermined size, comprising a discharge chute (2) having a chute channel (3) which comprises at least one tablet inlet (7), and having an actuating element (11), which can be pivoted between a first end position and a second end position, wherein tablets fed to the tablet inlet (7) are fed in the first end position of the actuating element (11) to at least a first tablet outlet (9) of the chute channel (3), wherein tablets fed to the tablet inlet (7) are fed in the second end position of the actuating element (11) to at least a second tablet outlet (8) of the chute channel (3), and wherein the actuating element (11) in the first end position points in a direction of a first wall (4), of the discharge chute (3), which delimits the chute channel (3), wherein in each position of the actuating element (11), between the actuating element (11) and the first wall (4), a passage is formed which is larger than a maximum extension of the tablets produced by the tablet press (1).

2. The tablet press (1) according to claim 1, wherein the actuating element (11) in the first end position points in a direction of a recess (20) that is formed by a first wall portion (21) of the first wall (4).

3. The tablet press (1) according to claim 1, wherein a pivoting of the actuating element (11) beyond the first end position is blocked by a first stop element, and/or wherein a pivoting of the actuating element (11) beyond the second end position is blocked by a second stop element.

4. The tablet press (1) according to claim 1, wherein the passage in the first end position is at most 30 mm.

5. The tablet press (1) according to claim 2, wherein the first wall portion (21) is formed at least in regions by an insert part (18A) which is inserted into a cavity (17) of the first wall (4) and is detachably connected to the discharge chute (2).

6. The tablet press (1) according to claim 1, wherein the first wall (4) in the first end position of the actuating element (11) extends in an arc-shaped manner along a free first end (12) of the actuating element (11).

7. The tablet press (1) according to claim 2, wherein second wall portion (23) of the first wall (4) arranged upstream of the first wall portion (21) of the first wall (4) extends in a sliding direction of the discharge chute (2), and/or wherein a third wall portion (24) of the first wall (4) arranged downstream of the first wall portion (21) extends in the sliding direction of the discharge chute.

8. The tablet press (1) according to claim 7, wherein the second wall portion (23) is formed at least in regions by an insert part (18A).

9. The tablet press (1) according to claim 1, wherein the chute channel (3) is divided by a partition wall (14) arranged downstream of the actuating element (11) into a first chute channel part (15) assigned to the first tablet outlet (8) and a second chute channel part (16) assigned to the second tablet outlet (9).

10. The tablet press (1) according to claim 1, wherein the tablet press (1) comprises a bottom (6) extending perpendicular to the first wall (4).

11. The tablet press (1) according to claim 1, wherein the chute channel (3) comprises a third tablet outlet (10), wherein tablets fed to the tablet inlet (7) are selectively fed in the first end position to the first tablet outlet (8) or the third tablet outlet (10), and/or wherein tablets fed to the tablet inlet (7) are selectively fed in the second end position to the second tablet outlet (9) or the third tablet outlet (10).

12. A discharge system (27) for a tablet press (1) with a discharge chute (2) comprising a chute channel (3) with at least one tablet inlet (7) and an actuating element (11), which can be pivoted between a first end position and a second end position, wherein tablets fed to the tablet inlet (7) are fed in the first end position of the actuating element (11) to at least a first tablet outlet (8) of the chute channel (3), wherein tablets fed to the tablet inlet (7) are fed in the second end position of the actuating element (11) to at least a second tablet outlet (9) of the chute channel (3), and wherein a first wall of the discharge chute (3) delimiting the chute channel (3) comprises a cavity (17), and having at least one insert part (18A) which can be inserted into the cavity (17), wherein the insert part (18A) inserted into the cavity (17) also forms the first wall (4), wherein the actuating element (11) in the first end position points in a direction of the inserted insert part (18A), and wherein when the insert part (18A) is inserted, a passage is formed between the actuating element (11) and the first wall (4) in each position of the actuating element (11).

13. The discharge system (27) according to claim 12, wherein the discharge system (27) comprises at least one further insert part (18B, 18C, 18D, 18E), wherein either the insert part (18A) or the further insert part (18B, 18C, 18D, 18E) can be inserted into the cavity (17), and wherein the passage between the actuating element (11) and the first wall (4) is different when the insert part (18A) is inserted than when the further insert part (18B, 18C, 18D, 18E) is inserted.

14. The discharge system (27) according to claim 13, wherein the discharge system (27) comprises a further insert part (18E) which is configured such that when the further insert part (18E) is inserted, the actuating element (11) in the first end position rests against the inserted further insert part (18E).

15. A tablet press (1), which is configured to produce tablets of a predetermined size, comprising a discharge system (27) according to claim 12.

16. (canceled)
